(19) United States
(12) Patent Application Publication
(10) Pub. No.: US 2019/0186583 A1
(43) Pub. Date: Jun. 20, 2019

(54) VALVE ARRANGEMENT AND DAMPER COMPRISING THE VALVE ARRANGEMENT

(71) Applicant: Swansea University, Swansea, South Wales (GB)

(72) Inventor: Paul Davies, Ammanford Dyfed (GB)

(73) Assignee: Swansea University, Swansea, South Wales (GB)

(21) Appl. No.: 16/327,926

(22) PCT Filed: Aug. 22, 2017
(86) PCT No.: PCT/GB2017/052473

§ 371 Date: Feb. 25, 2019

(30) Foreign Application Priority Data
Aug. 26, 2016 (GB) 1614553.4

(51) Int. Cl. F16F 9/348; F16F 9/46; F16K 15/14; F16K 17/18

(52) U.S. Cl. CPC F16F 9/3481; F16K 17/18; F16K 15/148; F16F 9/462

(57) ABSTRACT

The present invention relates to a valve arrangement particularly, but not exclusively, for use in dampers to control compression and optionally rebound properties of a shock absorber wherein the valve arrangement comprising a valve body having a first and second fluid flow pathway for enabling fluid flow from an upstream to a downstream location and the valve arrangement further comprises a plurality of operational configurations for controlling the flow rate of fluid flow.

The present invention relates to a valve arrangement particularly, but not exclusively, for use in dampers to control compression and optionally rebound properties of a shock absorber.

The present invention provides an improved valve arrangement.

According to the present invention there is a valve arrangement comprising a valve body having a first and second fluid flow pathway for enabling fluid flow from an upstream to a downstream location, wherein the first fluid flow pathway is restricted by a first fluid flow pathway valve for restricting fluid flow therethrough until a threshold fluid pressure is applied, the valve arrangement further comprising a first flow control arrangement in the second fluid flow pathway configured to adopt a plurality of operational configurations for controlling the flow rate of fluid flow through the second fluid flow pathway, and an adjustor arrangement for adjusting the first flow control arrangement between the plurality of operational configurations.

The valve arrangement is suitable for use in a damper to control compression and preferably rebound.

The present invention enables fine control of fluid flow under different fluid flow situations. If the fluid flow pressure is sufficiently low then fluid flow will not flow through the first fluid flow pathway due to the restriction by the first fluid flow pathway valve. Under this low pressure fluid acting upon the valve arrangement the fluid will pass through the second fluid flow pathway. The resistance to flow through this pathway can be controlled by the first flow control arrangement. However, in the event of sufficient fluid flow pressure then the first fluid flow pathway valve will open allowing increase of fluid flow from the upstream to the downstream location.

It is beneficial that there are a plurality of discrete operational configurations. The fluid flow characteristics can therefore be closely controlled.

The first flow control arrangement is preferably rotatable between the plurality of operational configurations. The first flow control arrangement may comprise a body having a plurality of openings, each opening configured to allow a different fluid flow rate therethrough. The plurality of openings beneficially have different cross sectional areas. The openings are preferably cylindrical. The body may be in the form of a disc. The plurality of openings are preferably in a sequence of increasing cross sectional areas circumferentially in a clockwise or anti-clockwise direction around the disc. The disc is beneficially positioned substantially perpendicular to the fluid flow.

In the application of a damper, the first flow control arrangement provides a reliable cross sectional area of a flow pathway dependent upon the selected operational configuration. Repeatable flow of fluid, preferably oil flow rate, is ensured at differing oil temperatures. Furthermore, adjustment to the flow characteristics is effective and simple whilst providing consistency of flow rate.

The valve body beneficially comprises a third and a fourth fluid flow pathway for fluid flow from the downstream to the upstream location, wherein the third fluid flow pathway is restricted by a second fluid flow pathway valve for restricting fluid flow therethrough until a threshold fluid flow pressure is applied, the valve arrangement further comprising a second flow control arrangement in the fourth fluid flow pathway configured to adopt a plurality of operational configurations for controlling the flow rate of fluid flow through the fourth fluid flow pathway.

The second fluid flow pathway valve may comprise the same beneficial features as the first fluid flow pathway valve. The first and second fluid flow pathway valves are preferably coaxial and spaced apart in the direction of fluid flow.

It will thus be appreciated that the valve arrangement may be a two way valve allowing fluid flow in both a first and an opposing second direction.

This beneficially enables independent control of flow characteristics in both the first and second flow directions.

Both of the first and second flow control arrangements are preferably in a fixed axial location. The switching between the operational configurations is beneficially achieved through rotation.

The adjustor arrangement is preferably configured to enable adjustment of the second flow control arrangement between the plurality of operational configurations. The first and second flow control arrangements are beneficially independently reconfigurable. The adjustor arrangement may comprise independent arrangements for independently adjusting the first and second fluid flow pathway valves. Alternatively, the adjustor arrangement may be moveable to selectively co-operate with the first or second flow control arrangements to enable adjustment thereof. This reduces the number of components and complexity whilst enabling independent adjustment.

The adjustor arrangement preferably comprises an actuator external to the valve body. The adjustor arrangement and preferably the actuator are beneficially user operable. The adjustor arrangement may be a physically or electronically operable.

The adjustor arrangement preferably comprises an engagement formation for selectively co-operating with a corresponding engagement formation of the first and second fluid flow pathway valves respectively.

The first and second fluid flow pathway valves are preferably axially spaced, and the adjustor arrangement is beneficially axially moveable. The adjustor arrangement can therefore be selectively used for either adjustment of the first or second fluid flow pathway valve.

The adjustor arrangement may comprise a user operable actuator operable to enable selection between the plurality of operational configurations, the user operable actuator being external of the valve body and being in communication with the engagement formation via a shaft, wherein the user operable actuator is moveable between a first engagement position for co-operation with the engagement formation of the first fluid flow pathway valve and a second engagement position for co-operation with the engagement formation of the second fluid flow pathway valve. The user operable actuator is preferably moveable between a third disengaged position whereby the engagement formation is disengaged from the first and second fluid flow pathway valves.

The present invention may also extend to a damper comprising a canister having a mounting structure at a first end and having a chamber therein, wherein the valve body is moveable through the chamber, the valve body being secured to a shaft at a proximal end where the shaft extends from the valve body through a second end of the canister, and a mounting structure located at the distal end of the shaft.

The damper during operation transfers kinetic energy into heat energy which has a significant effect upon the operation of damping characteristics. The present invention has a short fluid flowpath through the valve arrangement minimising the effect upon the damping characteristics. The volume of fluid in the damper can also be increased allowing improved heat transfer away from the damper into the surrounding atmosphere.

It will be appreciated that a mounting structure may be any structure suitable for securing to another body. In the event of using the damper in a vehicle the opposing ends will be mounted to a vehicle structure.

It will be appreciated that in a damper the valve body effectively forms a piston head and relative movement between the valve body and the canister means there is relative movement of the valve body through the chamber thus causing displacement of fluid from an upstream to a downstream side of the valve body.

The adjustor arrangement is beneficially carried by the shaft.

The distal end of the shaft may comprise a head, and the user operable actuator is preferably secured relative to the head. Furthermore, the head may also comprise the mounting structure.

The chamber may further comprise a moveable barrier therein defining a first chamber portion and a second chamber portion, the valve body being positioned in the first chamber portion wherein the moveable barrier and chamber wall are configured to retain a fluid in the first chamber portion and a gas in the second chamber portion.

Such a configuration is typically known as an air shock and the air is retained between the moveable barrier and the canister wall. Fluid is provided on the opposing side of the barrier in the chamber through which the valve body moves. There is beneficially an inlet port in the canister for enabling gas flow into the second chamber portion in order to control the pressure in the second chamber portion.

Aspects of the present invention will now be described by way of example only with reference to the accompanying drawings in which:

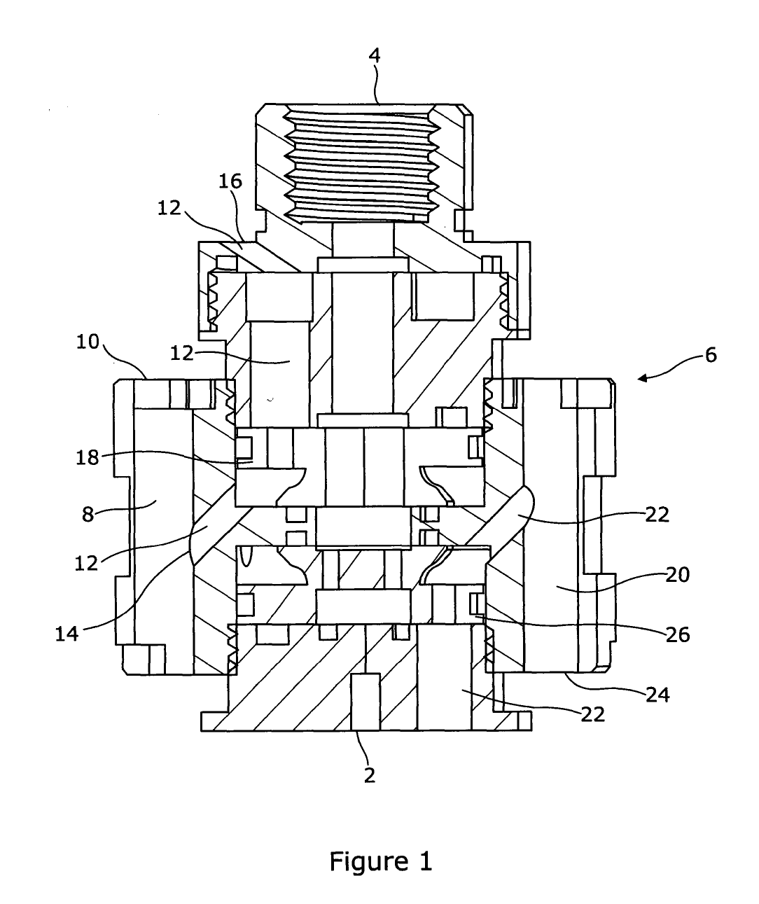

FIG. 1 is a schematic cross-sectional representation of a valve arrangement according to an exemplary embodiment of the present invention.

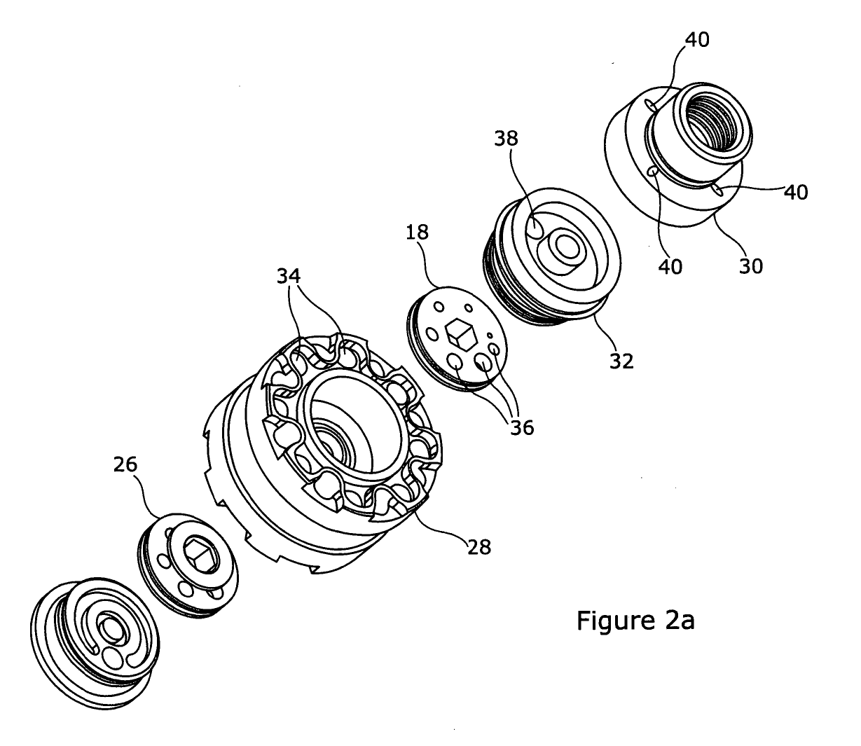

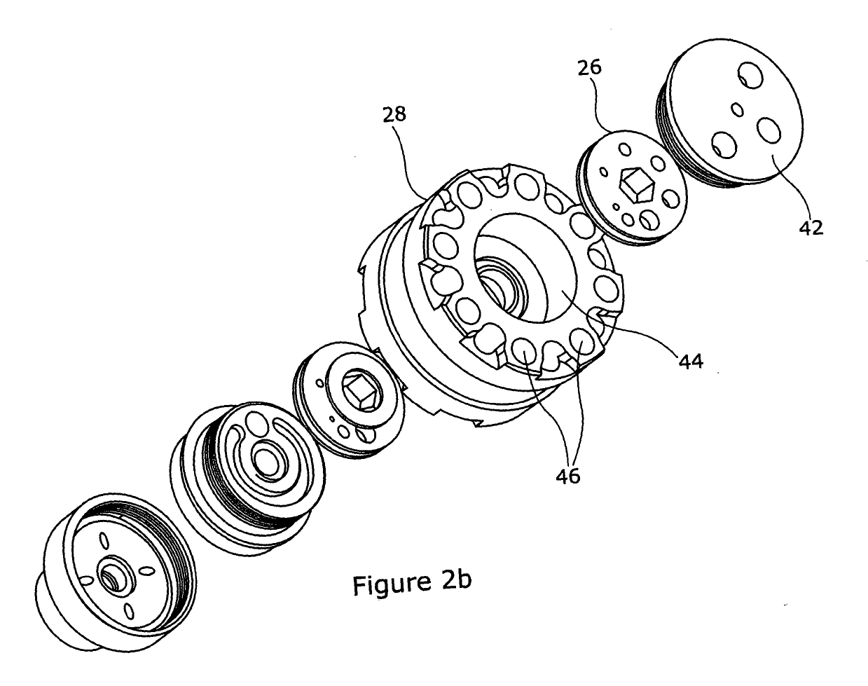

FIGS. 2a and 2b are exploded views of a valve arrangement according to an exemplary embodiment of the present invention from a first and second orientation.

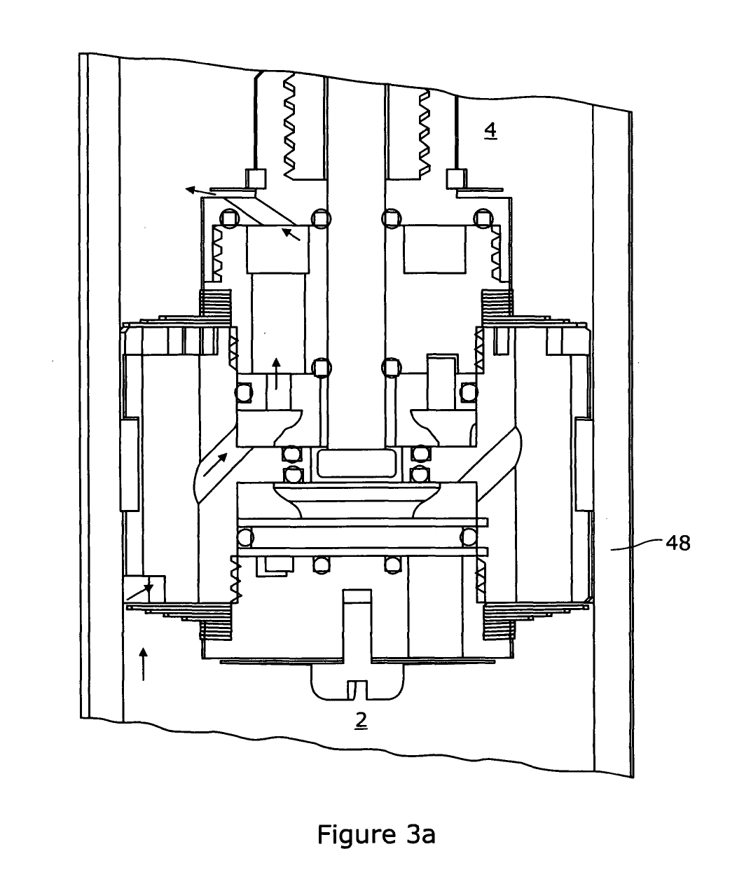

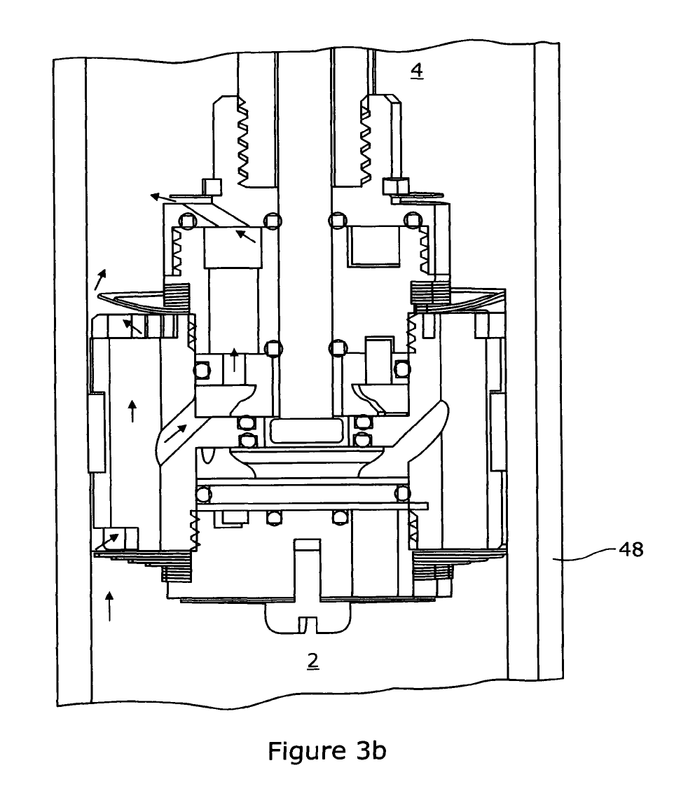

FIG. 3a is a schematic cross-sectional representation of fluid flow path through a valve arrangement according to an exemplary embodiment of the present invention under low pressure and FIG. 3b is a schematic representation of the valve arrangement and the associated fluid flow paths under high fluid pressure.

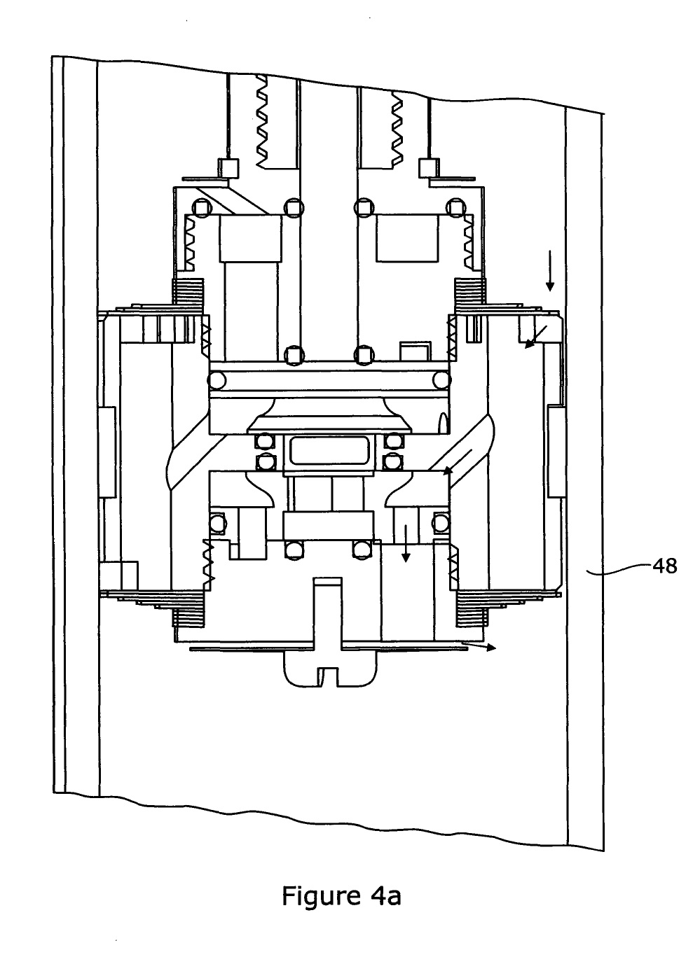

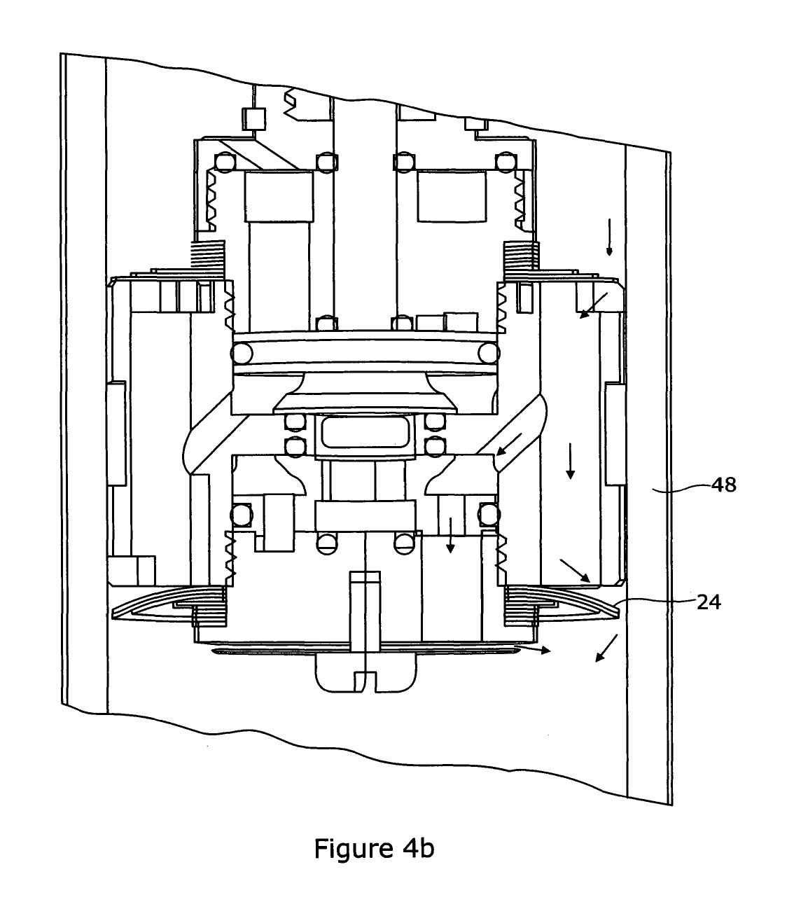

FIGS. 4a and 4b are schematic representations of fluid flow between a downstream and an upstream direction in a valve arrangement according to an exemplary embodiment of the present invention under low pressure and high pressure respectively.

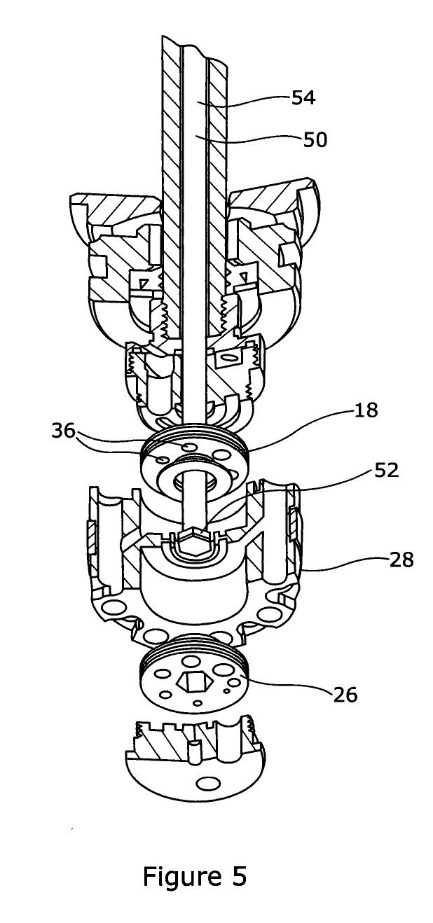

FIG. 5 is an exploded cross-sectional view of a valve arrangement according to an exemplary embodiment of the present invention.

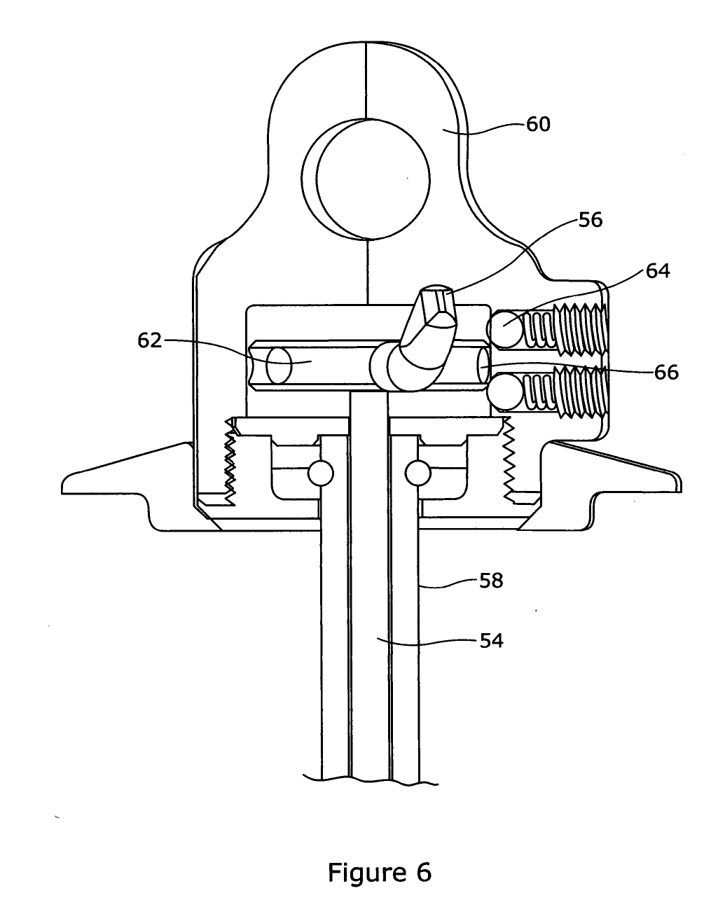

FIG. 6 is a schematic representation of an adjuster arrangement for use with the valve arrangement according to an exemplary embodiment.

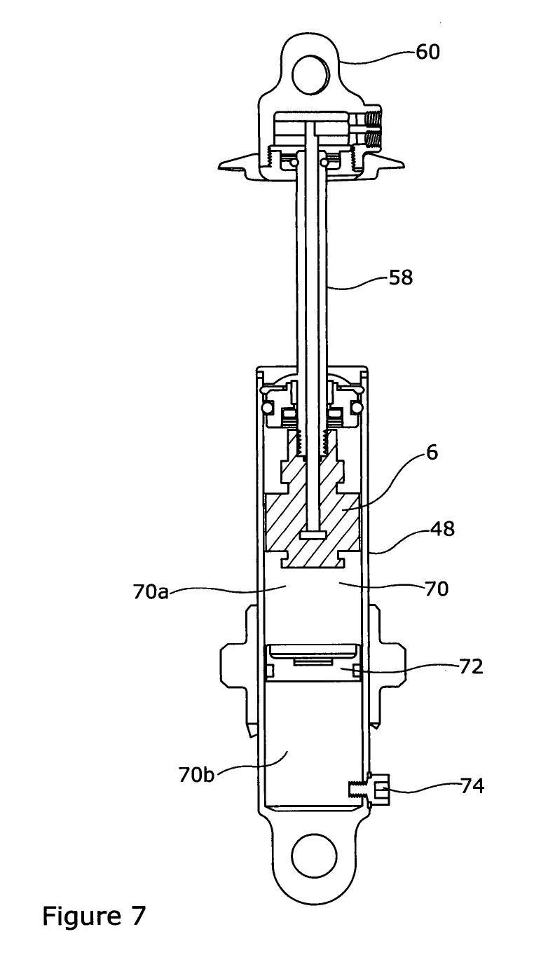

FIG. 7 is a cross-sectional representation of a damper incorporating the valve arrangement according to an exemplary embodiment of the present invention.

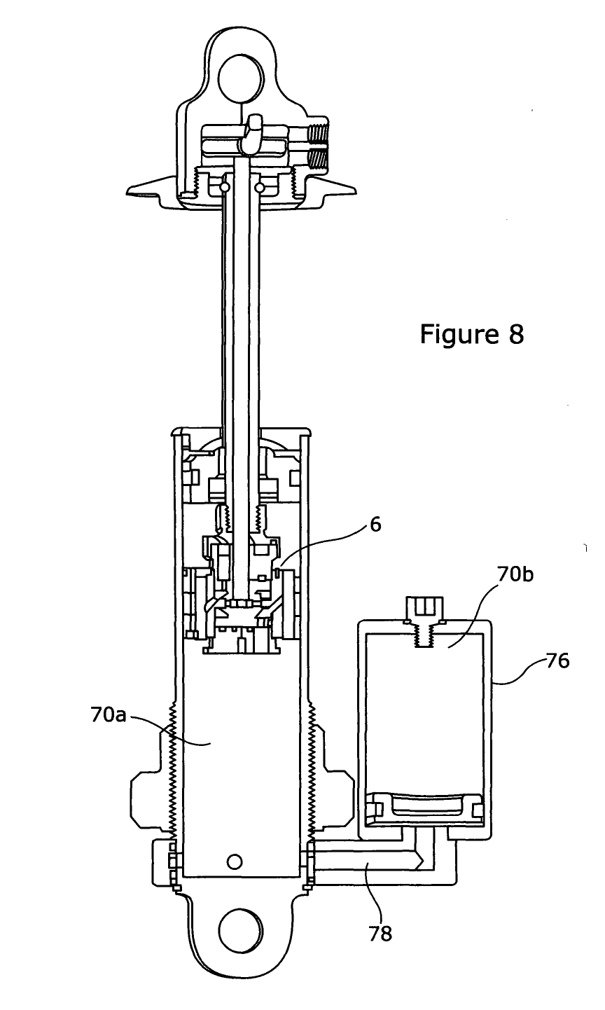

FIG. 8 is a cross-sectional representation of a further damper incorporating the valve arrangement according to an exemplary embodiment of the present invention.

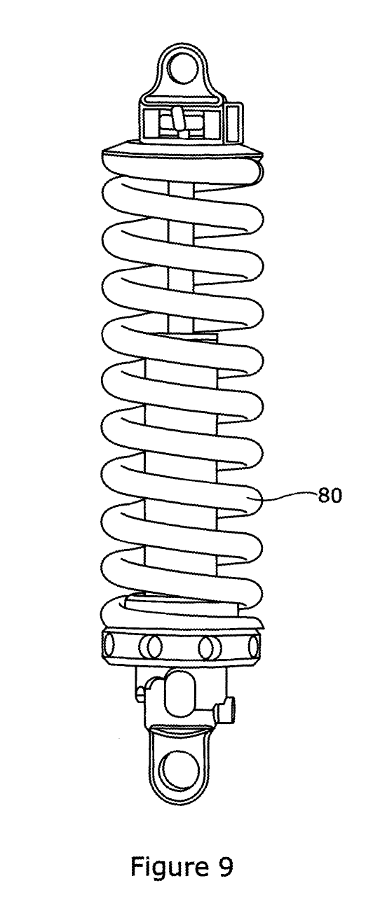

FIG. 9 is a perspective view of a damper incorporating the valve arrangement according to an exemplary embodiment of the present invention.

Referring to FIG. 1 a valve arrangement according to an exemplary embodiment is presented comprising a first end (2) and a second end (4) arranged to be positioned in a fluid flow. The first end (2) may be an upstream end and the second end (4) may be a downstream end. Thus, fluid flow is allowable at least from the upstream to the downstream ends.

The valve arrangement generally comprises a valve body (6) and through the valve body (6) is provided a first fluid flow pathway (8) and a second fluid flow pathway valve (10) for restricting fluid flow through the first fluid flow pathway until a threshold fluid pressure in the first fluid flow pathway (8) is present. A second fluid flow pathway (12) extends from an inlet (14) which in the embodiment presented branches from the first fluid flow pathway (8) through to outlet (16). This second fluid flow pathway allows passage of fluid from the upstream to the downstream ends. Intermediate the second fluid flow pathway (12) is a first flow control arrangement (18) which is configured to adopt a plurality of operational configurations for controlling the flow rate of fluid flow through the second fluid flow pathway (12). The first flow control arrangement (18) will be further described in subsequent figures. An adjuster arrangement (not shown in FIG. 1) is provided for adjusting the first flow control arrangement (18) between the plurality of operational configurations. The adjuster arrangement may comprise an actuator remote from the valve body.

The valve arrangement enables control of flow characteristics therethrough. Under low pressure fluid flow is prevented from flowing through the first fluid flow pathway (8) by the first fluid flow pathway valve (10) until a threshold pressure is applied onto the first fluid flow pathway valve (10) due to increased fluid flow. Until this pressure is achieved fluid flow is allowed through the second fluid flow pathway (12) and through the first flow control arrangement. As the pressure is increased the fluid flow continues through the second fluid flow pathway (12) however the increased pressure also activates the first fluid flow pathway valve (10) to enable passage of fluid therethrough. In a damper, low fluid flow is associated with low speed compression, and high fluid flow rate associated with high speed compression.

The valve body further comprises a third and fourth fluid flow pathway (20, 22) for fluid flow from the downstream or first end to the upstream or second end location. This enables the valve arrangement to allow dual flow directions. The third fluid flow pathway (20) includes a second fluid flow pathway valve (24) for restricting fluid flow therethrough until a threshold fluid flow pressure is presented. A second flow control arrangement (26) is positioned in the fourth fluid flow pathway and is configured to adopt a plurality of operational configurations for control the flow rate of fluid flow through the fourth fluid flow pathway. The second flow control arrangement (26) may be controlled by the same adjuster arrangement that controls the first flow control arrangement (18). Alternatively, a separate adjuster arrangement may be utilised. The adjuster arrangement is operable externally of the valve body. In a damper, low fluid flow is associated with low rebound speed, and high flow rate is associated with high speed rebound. The flow between upstream and downstream directions may therefore be controlled independently, with different flow pathways but utilising the same flow path configurations.

Further referring to FIG. 1 in combination with FIGS. 2a and b the components of the valve arrangement may be clearly identified. The valve body is in the form of a primary body component (28) in which seats the first and second flow control arrangements (18, 26). A first end cap (30) is provided to seat above the insert (32). The first fluid flow pathway (8) can be seen as a plurality of ports (34) projecting through the primary body component (28) where the second fluid flow pathway branches from ports (34) to pass through a conduit in the form of an opening (36) provided in the first flow control arrangement (18). The fluid flow pathway (12) then extends through a port (38) provided within the insert (32) and then passes through the ducts (40) in the cap (30). In the exploded views presented in FIGS. 2a and 2b the first fluid flow pathway valve has not been shown, however, it may take the form of a preloaded sprung element pushed against the port (34) openings and allow axial movement upon sufficient pressure from fluid passing through the ports (34) and acting on the sprung element.

Adjacent the first end (2) the reverse configuration is generally provided as shown in FIG. 2b whereby the second flow control arrangement (26) is received in the primary body component (28). Insert (42) is also received partially into the opening (44) in the primary body component (28). It will be appreciated that in this opposite flow direction ports (46) are open to allow fluid flow therethrough and thus through the fourth fluid flow pathway however again the second fluid flow pathway valve (not shown in FIG. 2b) will not allow fluid release until a threshold pressure is applied.

Now referring to FIG. 3a, arrows represent fluid flow through the valve arrangement under low fluid flow rate and thus low pressure. In the event the valve body forms the head of a damper this may be a low speed compression condition whereby the fluid pressure is relatively low and thus takes the second fluid flow pathway (12). In comparison t FIG. 3b, if there is a high flow rate, for example where there is a sudden compression force upon the damper, then fluid flow will continue through the second fluid flow pathway (12) but will further travel through the first fluid flow pathway (8) causing the first fluid flow pathway valve (10) to open. This valve (10) is clearly represented in FIGS. 3a and 3b and in FIG. 3a it is in the un-deflected or at rest configuration whereas in FIG. 3b the valve (10) can clearly be seen to be deflected upwardly to allow fluid flow therethrough. The first fluid flow pathway valve (10) is preferably replaceable or interchangeable with valves having different deflection characteristics in order to customise the resistance to high flow rate. In use as a damper, the valve arrangement is moveable through a canister (through either movement of the valve body or movement of the canister) and thus in the configuration as presented in FIGS. 3a and 3b the canister (48) is moving upwardly and/or the valve arrangement is moving downwardly to force fluid flow from the downstream or first end (2) to the downstream or second end (4).

FIGS. 4a and 4b represent a valve arrangement again within a canister or conduit (48) where the flow is in the opposite direction, or from the downstream or second end (4) to the upstream or first end (2). This is a typical event in an embodiment of the invention in a damper whereby there is relative movement of the valve body within the canister (48), where the canister moves towards the valve body (6) and/or the valve body (6) moves through the canister (48). FIGS. 4a and 4b represent the two states whereby in FIG. 4a there is low flow rate and thus the fluid takes the fourth fluid flow pathway. However, under high flow rate and thus high pressure the third fluid flow pathway is opened as shown in FIG. 4b through deflection of the second fluid flow pathway valve (24). By comparing FIGS. 4a and 4b the second fluid flow pathway valve (24) can be seen in the un-deformed or normal state in FIG. 4a and FIG. 4b in a deformed and open state. Thus, the flow characteristics are dependent upon the flow rate.

Referring now to FIG. 5 there is a sectional exploded representation of an exemplary embodiment of the present invention. The valve arrangement represented may have a variety of uses, but will be described with reference to a damper, typically used for a vehicle.

Using the same reference numerals as previous Figures and with particular reference to FIG. 2, there is a primary body component (28) with a first flow control arrangement (18) and second flow control arrangement (26) retained by the primary body component (28). The first and second flow control arrangements (18,26) may have the same configurations and mode of adjustment to control the fluid flow between upstream and downstream locations and will be described as such. The flow control arrangements (18,26) are rotatably mounted relative to the primary body component (28). They may take the form of a disc or plate rotatable between a plurality of operational configurations. A plurality of openings (36) are provided each configured to allow a different flow rate through them. This is achieved by varying the cross sectional area, and it will be seen from the figures that the effective size of each of the openings (36) increases circumferentially around body of the flow control arrangements (18,26). As such alignment of a particular opening (36) with the second fluid flow pathway (12) controls the fluid flow. So for example in a damper alignment of a larger opening in the fluid flow allows more fluid to flow through and this increases the low speed (or in other words low flow rate) compression damping.

Rotation of the flow control arrangements (18,26) between these operational configurations is achieved using an adjustor arrangement (50). This may take the form of an engagement formation (52) for engaging with the one or both flow control arrangements (18,26). In the embodiment presented it will be appreciated that both first and second flow control arrangements (18,26) are presented and thus the adjustor arrangement (50) is moveable between configurations to allow selective adjustment of the flow control arrangements (18,26). The engagement formation takes the form of a head extending from a rod (54) which in turns projects out of the valve body to allow external operation by a user. An exemplary embodiment of this is presented with respect to FIG. 6. The engagement formation (52) and rod (54) are axially movable to cause rotation of the flow control arrangements (18,26) through selective cooperation with the first or second flow control arrangements (18,26).

Referring to FIG. 6 the adjuster arrangement (50) further comprises a user operable actuator (56) that enables a user to select between adjustment of the first or second flow control arrangements (18,26) and also enables selection between the preferred opening (36). The rod (54) is intermediate the engagement formation (52) and actuator (56). The rod (54) is carried by shaft (58). In a damper the valve arrangement is provided at the distal end of the shaft (58) and forms a piston head moveable through the canister (48). A mounting structure (60) is provided for mounting the damper to a frame of a vehicle for example. The adjuster arrangement (50) is axially moveable and in the configuration as presented in FIG. 6 is at an intermediate configuration whereby the engagement formation (52) is not engaged with either of the first or second float control arrangements (18, 26). Movement axially in an upward direction as presented in FIG. 6 enables engagement of the user operable actuator (56), and in particular formation (62) intermediate the actuator (56) and rod (54), to cooperate with a spring loaded ball bearing (64) which in turn cooperates with a recess (66) in the formation (62).

This means that a corresponding opening (36) in the first flow control arrangement (18) is aligned in the second fluid flow pathway. Rotation of the actuator (56) and thus formation (62) and rod (54) disengages the ball bearing (64) from recess (66). Once rotation is sufficient to align a new opening (36) with the second fluid flow pathway the ball bearing (64) will engage with another circumferentially spaced recess (66). Therefore, compression (low speed) characteristics can be selected. In the event of requirement to adjust the low speed rebound characteristics, the adjustor arrangement is moved axially in the opposing direction and the same operation is repeated.

It will be appreciated that openings (36) in either or both of the first or second flow control arrangement (18,26) may be intentionally misaligned with the respective fluid flow paths. This is beneficial under certain operative requirements as this effectively blocks the fluid flow path and provides a lock out feature for the compression or rebound cycle of a damper unless high fluid flow rate is imparted upon the first flow pathway valve or second fluid flow pathway valve (10,24) respectively. This provides a beneficial feature under certain conditions, such as when the damper is used on a bicycle. This feature may be used for climbing purposes.

Referring now to FIG. 7 a full damper is presented where the valve arrangement forms the head of a piston passing through canister (48). There are significant advantages associated with such an arrangement. The fluid flow pathways between the first end or upstream end and second end or downstream end (2,4) are provided within the valve body. Thus, the flow pathway is very short which improves performance due to reduced fluid temperature and lower viscous shear. A second significant advantage is that control of the fluid flow in both directions between the upstream and downstream sides of the valve arrangement are completely independently controllable. The provision of opening (36) of fixed dimensions and that are discreet from each other provides consistent performance and repeatability. Adjustment is also therefore guaranteed as the size of the opening is always the same under a particular setting. Furthermore, compression and rebound are isolated from each other meaning that adjustment of each is independently selectable.

In FIG. 7 an air damper has been represented whereby the valve arrangement carried by the shaft (58) moves through the chamber (70) in both directions dependent upon compression or rebound causing fluid to flow through the valve body. The chamber (70) is separated by a floating barrier (72) which separates the chamber into chamber portions (70a,70b). In chamber portion (70a) fluid comprising oil may be found, whereas in chamber (70b) pressurized gas is input through valve (74) to act as a spring under compression.

FIGS. 8 and 9 are further exemplary embodiments of the present invention. FIG. 8 is effectively the same the embodiment of FIG. 7 however in such an embodiment the effective stroke of the damper has been increased through the provision of a piggy back arrangement (76) whereby chamber (70b) has been positioned generally parallel to chamber (70a) connected via conduit (78).

Referring to FIG. 9, a damper is presented whereby instead of an air chamber to provide resistance to compression an external compression spring (80) has been utilised.

Aspects of the present invention have been described by way of example only and it will be appreciated to the skilled addressee that modifications and variations may be made without departing from the scope of protection afforded by the appended claims.

1. A valve arrangement comprising a valve body having a first and second fluid flow pathway for enabling fluid flow from an upstream to a downstream location, wherein the first fluid flow pathway is restricted by a first fluid flow pathway valve for restricting fluid flow therethrough until a threshold fluid pressure is applied, the valve arrangement further comprising a first flow control arrangement in the second fluid flow pathway configured to adopt a plurality of operational configurations for controlling the flow rate of fluid flow through the second fluid flow pathway, and an adjustor arrangement for adjusting the first flow control arrangement between the plurality of operational configurations.

2. The valve arrangement according to claim 1, wherein the first flow control arrangement is rotatable between the plurality of operational configurations.

3. The valve arrangement according to claim 1, wherein the first flow control arrangement comprises a body having a plurality of openings, each opening configured to allow a different fluid flow rate therethrough.

4. The valve arrangement according to claim 3, wherein the plurality of openings have different cross sectional areas.

5. The valve arrangement according to claim 1, wherein the valve body comprises a third and a fourth fluid flow pathway for fluid flow from the downstream to the upstream location, wherein the third fluid flow pathway is restricted by a second fluid flow pathway valve for restricting fluid flow therethrough until a threshold fluid flow pressure is achieved, the valve arrangement further comprising a second flow control arrangement in the fourth fluid flow pathway configured to adopt a plurality of operational configurations for controlling the flow rate of fluid flow through the fourth fluid flow pathway.

6. The valve arrangement according to claim 5, wherein the first and second flow control arrangements are positioned coaxially.

7. The valve arrangement according to claim 5, wherein the adjustor arrangement is configured to enable selection of the second flow control arrangement between the plurality of operational configurations.

8. The valve arrangement according to claim 7, wherein the adjustor arrangement is moveable to selectively co-operate with the first or second flow control arrangement.

9. The valve arrangement according to claim 1, wherein the adjustor arrangement comprises an actuator external to the valve body.

10. The valve arrangement according to claim 1, wherein the adjustor arrangement comprises an engagement formation for selectively co-operating with a corresponding engagement formation of the first and second flow control arrangements respectively.

11. The valve arrangement according to claim 10, wherein the first and second fluid flow control arrangements are axially spaced apart, and the adjustor arrangement is axially moveable.

12. The valve arrangement according to claim 10, wherein the adjustor arrangement comprises a user operable actuator operable to enable selection between the plurality of operational configurations, the user operable actuator being external of the valve body and in communication with the engagement formation via a shaft, wherein the user operable actuator is moveable between a first engaged position for co-operation with the engagement formation of the first flow control arrangement and a second engagement position for co-operation with the engagement formation of the second flow control arrangement.

13. The valve arrangement according to claim 12, wherein the user operable actuator is further moveable between a third disengaged position whereby the engagement formation is disengaged from the first and the second flow control arrangements.

14. A damper comprising a canister having a mounting structure at a first end and having a chamber therein and the valve arrangement of claim 1, wherein the valve body is moveable through the chamber, the valve body being secured at a proximal end to a shaft extending from the valve body through an opening in a second end of the canister, and a second mounting structure located at the distal end of the shaft.

15. The damper according to claim 14, wherein the adjustor arrangement is carried by the shaft.

16. The damper according to claim 14, wherein the shaft comprises a head, the mounting structure and user operable actuator being secured to the head.

17. (canceled)
